(19) United States
(12) Patent Application Publication
(10) Pub. No.: US 2015/0209605 A1
(43) Pub. Date: Jul. 30, 2015

(54) NOZZLE WITH RADIAL SPRAY JET CAPABILITY

(71) Applicant: Akron Brass Company, Wooster, OH (US)

(72) Inventor: Brian E. Keim, Wooster, OH (US)

(21) Appl. No.: 14/610,067

(22) Filed: Jan. 30, 2015

Related U.S. Application Data
(60) Provisional application No. 61/933,543, filed on Jan. 30, 2014.
(60) Provisional application No. 62/077,612, filed on Nov. 10, 2014.

(51) Int. Cl. A62C 31/03; B05B 1/26

(52) U.S. Cl. CPC A62C 31/03; B05B 1/265

(57) ABSTRACT

One or more techniques and/or systems are disclosed for a nozzle that is capable of discharging a radial spray fluid pattern, between one-hundred and seventy and one-hundred and eighty degrees from nozzle fluid flow. The nozzle may be configured to selectably alter the spray pattern between the radial spray fluid pattern and a substantially straight spray pattern of fluid. The nozzle may be devised to provide a straight fluid stream profile that mitigates divergence of the fluid stream, and may increase an overall reach of the fluid.

### CROSS-REFERENCE TO RELATED APPLICATIONS

This application claims priority to Provisional Patent Application, U.S. Ser. No. 61/933,543, entitled NOZZLE WITH RADIAL SPRAY JET CAPABILITY, filed Jan. 30, 2014, which is incorporated herein by reference; and claims priority to Provisional Patent Application, U.S. Ser. No. 62/077,612, entitled INCREASED HELIX FOG NOZZLE, filed Nov. 10, 2014, which is incorporated herein by reference.

### BACKGROUND

Typically, a nozzle can be connected to discharge portion of a hose and used to direct fluids that are discharged from the hose. A nozzle can comprise on/off mechanism, such as a valve, for selectably controlling discharge of fluids from the nozzle. A nozzle may also comprise a means for varying a flow rate and/or pressure of discharged fluids, and/or a means for varying a spray pattern of the discharged fluids. Current and prior hand-held nozzles, which may be used for fire suppression, typically produce a spray pattern of fluid that ranges from substantially straight (e.g., in-line with the flow of fluid from the hose, or an angle of zero degrees) to a spray angle of about 130 degrees with respect to an axis of the elongate fluid passage of the nozzle. Current hand-held nozzles may not be able to direct a spray of fluid at or near right angles, for example, to reach past an obstruction or doorway. Some current stationary, “water wall” monitors utilize directional tips and fans to produce a radial spray jet of fluid. Such monitors have limited portability while in use, and are typically used only for fire or heat containment.

A fog nozzle, often used for firefighting, can provide a large area of small droplets of fluid to provide greater heat absorption, when compared with a straight fluid stream. As an example, some fog nozzles may utilize a baffle head and discharge tube that can develop up to a wide fog pattern (e.g., one-hundred and thirty degrees). In a straight stream, a shape of the baffle head and discharge tube of a typical fog nozzle may generate turbulence, which can give rise to a divergent stream profile, for example, where, as flow rate increases, divergence of the stream can also increase. A divergent stream profile may affect desired stream quality and overall reach of the fluid.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

As provided herein, a nozzle capable of discharging a radial spray fluid pattern at between one-hundred and seventy and one-hundred and eighty degrees from an axis of an elongate fluid passage of the nozzle. Further, the nozzle may be configured to selectably alter the spray pattern between the radial spray fluid pattern and a substantially straight spray pattern of fluid. The radial spray pattern of fluid can be oriented generally perpendicularly to a direction of fluid flow through the nozzle, for example, thereby creating a “water wall” or a “water curtain,” which may provide a wide field of fluid distribution. The nozzle can also be devised to provide a straight fluid stream profile that mitigates divergence of the fluid stream, and may increase an overall reach of the fluid.

In one implementation, an example nozzle can comprise a discharge tube that is operably coupled with a nozzle body. In this implementation, the discharge tube can form a fluid passage that is configured to carry fluid to an output end of the nozzle. Further, the discharge tube can terminate in an output lip at the output end, where the output lip comprises a convex first radius of curvature. Additionally, the nozzle can comprise a baffle head that is operably coupled with the nozzle body, and the baffle head is disposed distally from the output end of the discharge tube. The baffle head can comprise a concave second radius of curvature on its proximal side. The configuration of the underside of the baffle head can complement the first radius of curvature of the output lip, resulting in directing of an output flow of fluid substantially perpendicular to an axis of nozzle fluid flow.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof and wherein:

FIG. 1A is a component diagram illustrating a sectional view of an example implementation of a nozzle configured to provide a radial spray pattern substantially perpendicular to the direction of fluid flow.

FIG. 1B is a component diagram illustrating a close-up sectional view of a portion of an example implementation of a nozzle described herein.

FIG. 2A is a component diagram illustrating a sectional view of an example implementation of a nozzle configured to provide a radial spray pattern substantially perpendicular to the direction of fluid flow.

FIG. 2B is a component diagram illustrating a close-up sectional view of a portion of an example implementation of a nozzle described herein.

FIG. 3A is a component diagram illustrating a sectional view of an alternate example implementation of a nozzle configured to provide a radial spray pattern substantially perpendicular to the direction of fluid flow.

FIG. 3B is a component diagram illustrating a close-up sectional view of a portion of an alternate example implementation of a nozzle described herein.

FIG. 4A is a component diagram illustrating a sectional view of an alternate example implementation of a nozzle configured to provide a radial spray pattern substantially perpendicular to the direction of fluid flow.

FIG. 4B is a component diagram illustrating a close-up sectional view of a portion of an alternate example implementation of a nozzle described herein.

FIG. 5 is a component diagram illustrating a sectional view of an example implementation of a nozzle in accordance with one or more portions of one or more apparatus described herein.

FIG. 6 is a component diagram illustrating an example implementation of a nozzle in accordance with one or more portions of one or more apparatus described herein.

FIG. 7 is graphical representation of one or more characteristics of one or more portions of systems described herein.

FIGS. 8A and 8B are component diagrams illustrating a sectional view of an example implementation of a nozzle in accordance with one or more portions of one or more apparatus described herein.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices may be shown in block diagram form in order to facilitate describing the claimed subject matter.

A nozzle, which can be coupled to a fluid supply, such as a high capacity hose (e.g., fire hose), may be configured to direct an output flow of fluid in a radial spray that is substantially perpendicular to the direction of fluid flow in the nozzle. That is, for example, the nozzle may be configured to direct the fluid output from the nozzle in a three-hundred and sixty degree, radial spray pattern, where the spray pattern creates a type of water wall in front of the operator. In one implementation, a baffle head that is fixed in a central area of the fluid flow can direct the fluid flow across the face of the output (e.g., distal) end of the nozzle, where the face of the output end comprises a planar surface, disposed perpendicular to the axis of fluid flow in the nozzle.

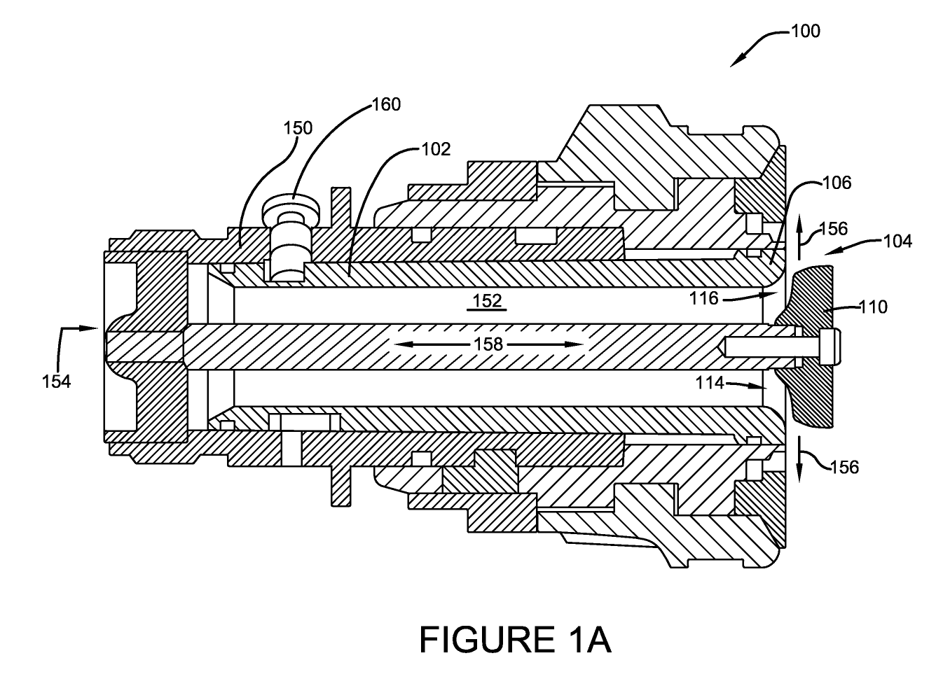

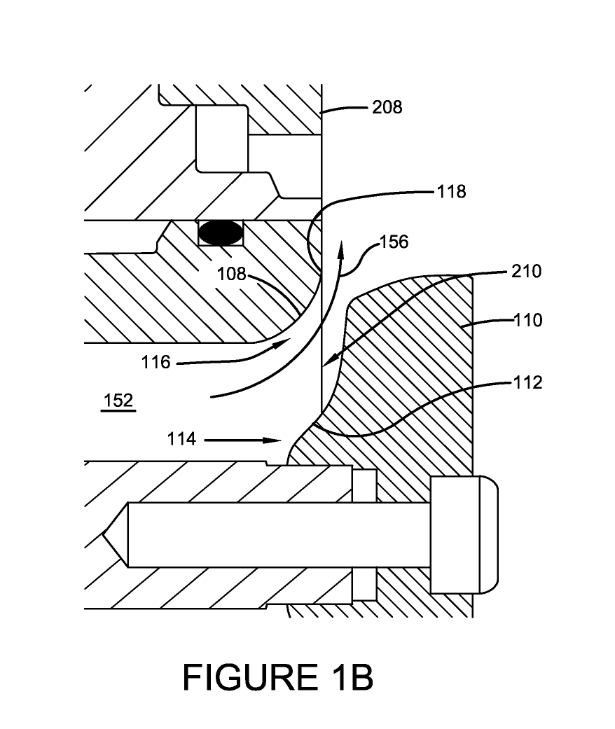

FIG. 1A is a component diagram illustrating an exemplary nozzle 100, which may be configured to provide a radial spray pattern that is substantially perpendicular to the direction of fluid flow in the nozzle 100. FIG. 1B is a component diagram illustrating a magnified view of a portion of the exemplary nozzle 100. In this implementation, the exemplary nozzle 100 comprises a discharge tube 102 that is operably coupled with a nozzle body 150. The discharge tube 102 forms a nozzle fluid passage 152 that is configured to carry fluid from a nozzle fluid inlet end 154 to an output end 104 of the discharge tube 102. The discharge tube 102 terminates in an output lip 106 at the output end 104, and the output lip 106 comprises a first convex shape 108.

Further, the exemplary nozzle comprises a baffle head 110 that is operably coupled with the nozzle body 150. The baffle head 110 comprises a concave shape 112, disposed on a proximal side 114 (e.g., underside that receives a fluid flow) of the baffle head 110. Further, the baffle head 110 is disposed distally from the output end 104 of the discharge tube 102 to form a fluid discharge channel 116 between the output lip 106 and the baffle head 110. In this exemplary implementation 100, the fluid discharge channel 116 is defined by the first convex shape 108 of the output lip 106 and the concave shape 112 of the baffle head 110. Additionally, the fluid discharge channel 116 is configured to direct an output flow of fluid 156 substantially perpendicular to an axis of nozzle fluid flow 158 (e.g., direction of flow of the fluid in the nozzle fluid passage 152).

In one implementation, as illustrated in FIGS. 1A and 1B, the fluid discharge channel 116 comprises a converging channel (e.g., converging in a direction of fluid flow) that can be configured to increase a speed of the fluid flow between the fluid passage 152 and a fluid output 156. That is, the fluid discharge channel 116 becomes narrower from a point where the fluid flow enters the fluid discharge channel 116, created by the offset of the output lip 106 and proximal side 114 of the baffle head 110, to where the fluid flow exits the fluid discharge channel 116. For example, by directing the fluid flow through a narrowing channel, based on the Bernoulli's principle, the speed of flow will increase, while the fluid pressure decreases, between the inlet and outlet areas of the fluid discharge channel 116. As an example, the first convex shape 108 of the output lip 106 and the concave shape 112 of the baffle head may be configured to produce a desired acceleration of fluid flow, and configured to produce the desired direction of flow for the stream (e.g., perpendicular to the fluid flow in the nozzle, greater than one-hundred and seventy degrees wide).

In one implementation, the first convex shape 108 of the output lip 106 can comprise a first radius of curvature, and the concave shape 112 of the baffle head 110 can comprise a second radius of curvature. That is, for example, the first convex shape 108 may comprise an arc defined by the first radius of the curvature of the first convex shape 108, and the concave shape may comprise an arc defined by the second radius of the curvature of the concave shape 112. In one implementation, the arc of the baffle head's concave shape may be indicative of an ellipse, which can be defined by a minor radius and major radius.

In one implementation, a diameter of a circle defined by a tangency point 118 on the first convex shape 108, defined by the first radius of curvature, at the distal end of the output lip 106, may be configured to be less than a minor diameter of the second radius of curvature of the concave shape 112 of the baffle head 110, where the second radius of curvature comprises an arc of an ellipse. That is, for example, when viewed in a bisected cross-section, at the point on the discharge tube's output end 104 where the first radius of curvature of the first convex shape 108 becomes a straight line (e.g., tangent to the curve), the tangency point 118 of the first radius of curvature of the first convex shape 108 may be identified for the distal end of the output lip 106. Further, in this example, a circle can be defined by the tangency point of the first radius of curvature, from which a diameter may be identified.

Additionally, when viewed in the bisected cross-section, the second radius of curvature of the concave shape 112 may be indicative of an arc that is a portion of an ellipse, which can be defined by a minor and major diameter. In this implementation, in this example, the diameter of the circle defined by the tangency point of the first radius of curvature can be configured to be less than the minor diameter of the ellipse indicated by the second radius of curvature. In this implementation, for example, the shape and the converging nature of the fluid discharge channel 116, created by the curve of the output lip 106 and curve of the proximal side 114 of the baffle head 110 can result in a substantially uniform, one-hundred and seventy to one-hundred and eighty degrees wide, radial spray pattern from the nozzle 100.

In an alternate implementation of the nozzle 100, the diameter of the circle defined by the tangency point on the first radius of curvature of the first convex shape 108, at the distal end of the output lip 106, may be greater than or equal to the minor diameter of the second radius of curvature of the concave shape 112 of the baffle head 110, where the second radius of curvature comprise the ellipse arc. In this alternate implementation, the nozzle 100 may be configured to output an output flow of fluid 156 that is substantially perpendicular to the fluid flow in the fluid passage 152. Further, in this implementation, a different spray pattern may be produced, having different spray characteristics, such as flow rate, pressure, turbulence, and back pressure.

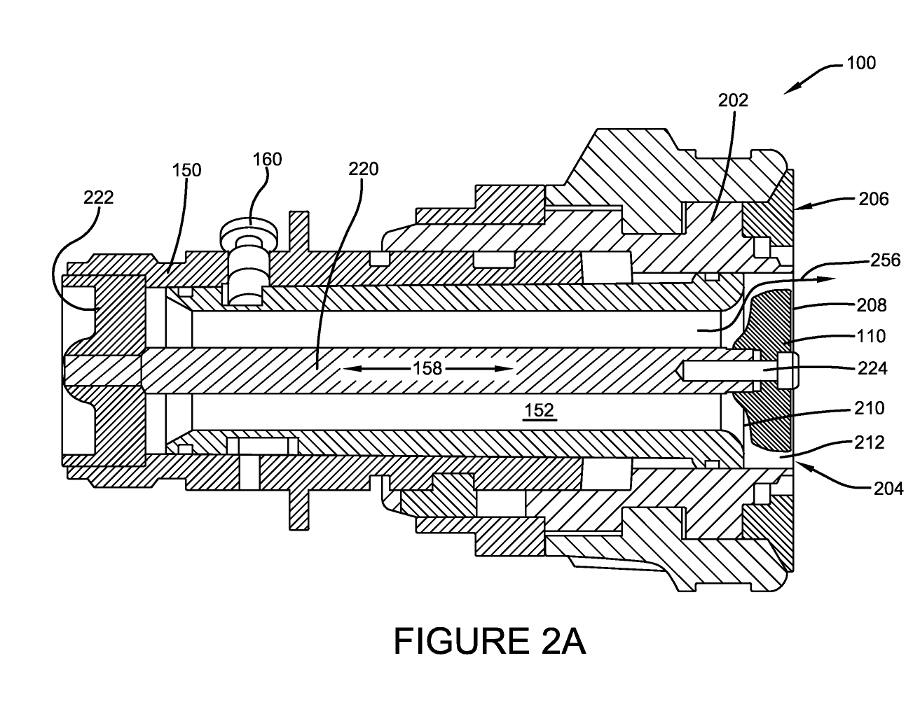

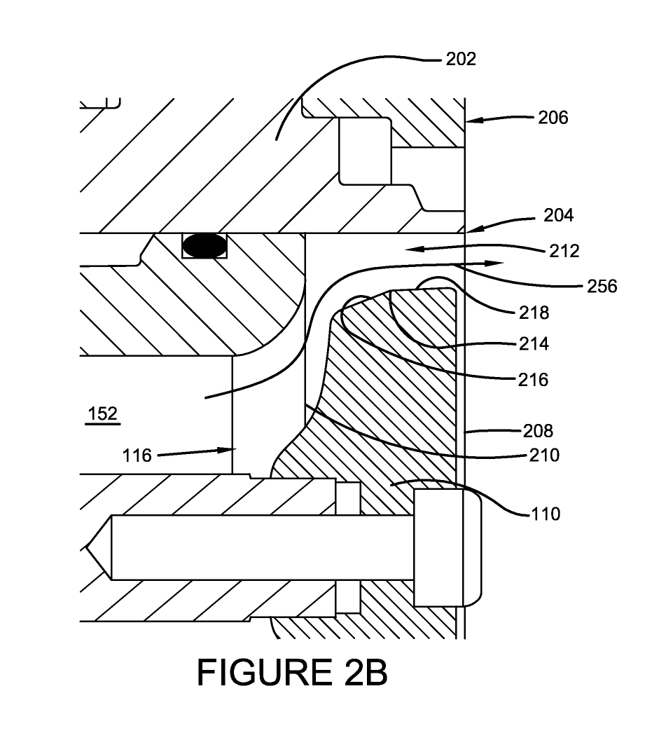

FIG. 2A is a component diagram illustrating the exemplary nozzle 100, which can be configured to provide a substantially straight stream that comprises a spray pattern of nearly zero degrees. FIG. 2B is a component diagram illustrating a magnified view of a portion of the exemplary nozzle 100. In this implementation, the exemplary nozzle 100 comprises a pattern sleeve 202 that can be operably coupled with the nozzle body 150. In this implementation, the pattern sleeve 202 can be configured to selectably translate along the axis of nozzle fluid flow 158, between a retracted position (e.g., as illustrated in FIGS. 1A and 1B) and an extended position 204.

With reference to FIGS. 1A and 1B, in one implementation, the pattern sleeve 202 can comprise a distal face 206 that lies in a plane 208 substantially perpendicular to the axis of nozzle fluid flow 158. Further, in this implementation, when the pattern sleeve 202 is disposed in the retracted position, as illustrated in FIGS. 1A and 1B, the plane 208 of the distal face 206 of the pattern sleeve 202 is disposed at or below a plane 210 formed by the output end 104 of the discharge tube 102. As an example, when the pattern sleeve 202 is set to the retracted position, the pattern sleeve 202 does not create an impediment for the output flow of fluid 256 directed perpendicularly to the fluid flow in the nozzle fluid passage 152.

In one implementation, as illustrated in FIGS. 2A and 2B, the pattern sleeve 202 can comprise a pattern tube 212 that is operably coupled with the nozzle body 150, located at the output end 104 of the discharge tube 102. In this implementation, when the pattern sleeve 202 is disposed in the extended position 204, the baffle head 110 is disposed substantially inside the pattern tube 212. In the extended position, in this implementation, a resulting output flow of fluid 256 from the distal end of the pattern tube 212 may be substantially parallel to the axis of nozzle fluid flow 158. That is, for example, when the pattern sleeve 202 is extended, the distal face 206 of the pattern sleeve 202 may be disposed at or near the distal face of the baffle head 110, which allows the baffle head 110 to lie inside the pattern tube 212. In this example, the output flow of fluid 256 can be directed into the pattern tube 212 by the fluid discharge channel 116, at which point the pattern tube 212 can direct the output flow of fluid 256 in a direction that is substantially parallel to the axis of nozzle fluid flow 158 (e.g., a straight stream).

In one implementation, the baffle head 110 can comprise a baffle profile 214. When the nozzle is disposed in a straight stream pattern configuration, such as when the pattern sleeve 202 is disposed in the extended position 204, the baffle profile can be configured to increase the speed of the fluid flow to a fluid output of the nozzle 100. For example, the baffle profile 214 may create a converging channel in conjunction with a wall of the pattern tube 212. As described above for the fluid discharge channel 116, a converging channel can cause fluid flow speed to increase, for example, while fluid pressure decreases. Further, when the nozzle is disposed in a straight stream pattern configuration the baffle profile 214 can be configured to mitigate fluid flow turbulence and fluid flow back pressure in the nozzle 100.

In one implementation, the baffle profile 214 can comprise a second convex shape, for example, as illustrated in FIGS. 2A and 2B, which may provide the converging channel in conjunction with the wall of the pattern tube 212, described above. Further, for example, the second convex shape of the baffle profile 214 may provide for the mitigation of backflow pressure in the nozzle fluid passage 152 and/or fluid discharge channel 116. In one implementation, the second convex shape of the baffle profile 214 may comprise a third radius of curvature.

In another implementation, the second convex shape of the baffle profile 214 may comprise a first face 216 disposed at a first angle and a second face 218 disposed at a second angle. In this implementation, for example, the first angle at which the first face 216 is disposed, can be configured to reduce turbulence of fluid flowing from the fluid discharge channel 116 into the pattern tube 212 and out of the discharge end of the nozzle. Further, for example, the first angle at which the first face 216 is disposed, can be configured to mitigate back pressure in the fluid passage 152, which may result from the fluid being forced through the converging channel of the fluid discharge channel 116. In one implementation, the second angle at which the second face 218 is disposed can be configured to facilitate acceleration of fluid flow when the nozzle is disposed in the straight stream configuration, such as when the pattern sleeve 202 is disposed in the extended position. In this implementation, for example, the second angle at which the second face 218 is disposed can create a converging channel with the wall of the pattern tube 212. In this way, for example, the converging channel can increase the speed of fluid flow, which reducing the fluid pressure.

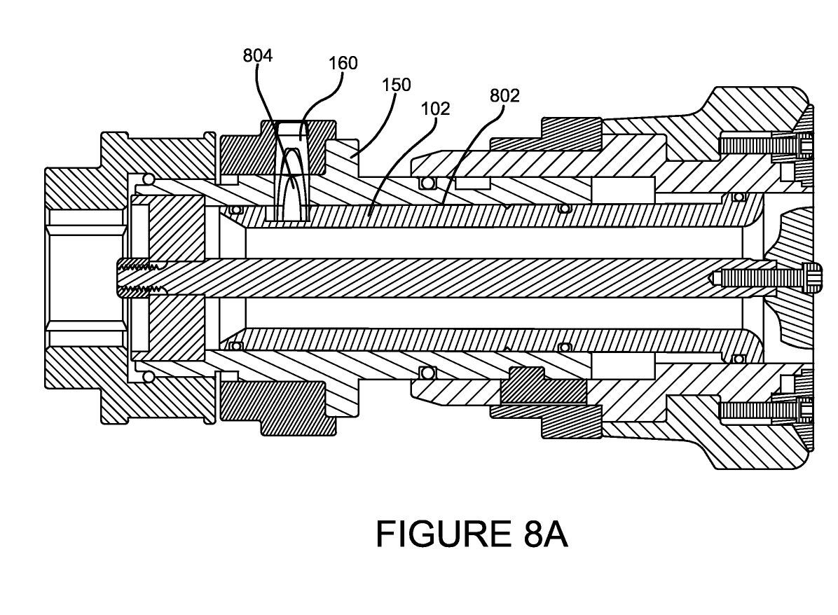

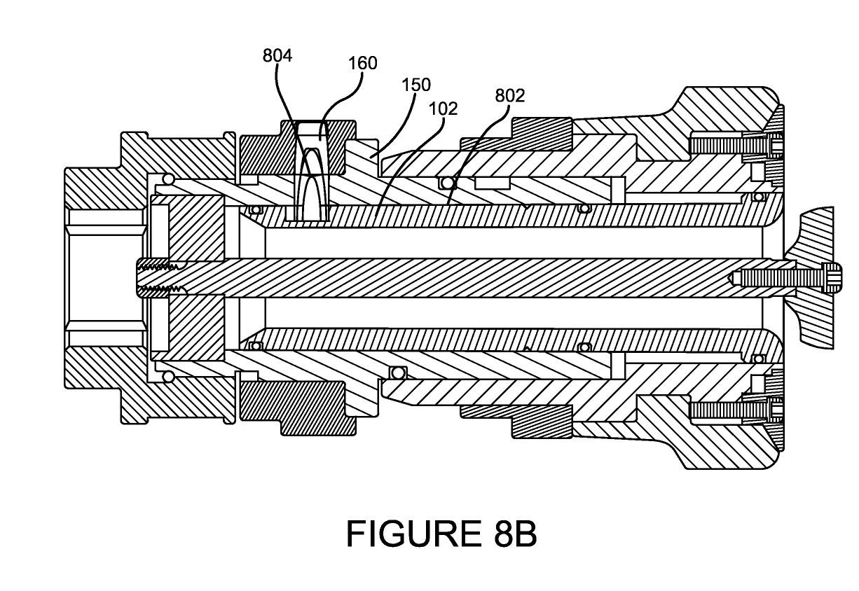

Further, as illustrated in FIGS. 1A, 8A and 8B, in one implementation, the discharge tube 102 can be selectably, non-movably coupled to the nozzle body 150. That is, for example, the discharge tube 102 may be non-movably coupled with the nozzle body 150 using a type of fastener 160, which may be selectably (e.g., or fixedly) fastened and loosened to engage and disengage the coupling of the discharge tube 102 to the nozzle body 150. In one implementation, the fastener 160 can comprise a cam pin 804 that may be indexed along a corresponding guiding groove 802 in the discharge tube 102, by means of a control ring (not shown). In this way, for example, the discharge tube 102 may remain in a relatively non-movable condition, with respect to the nozzle body 150, when the nozzle 100 is in operation.

Additionally, as illustrated in FIG. 2A, in one implementation, the baffle head 110 can be coupled to a stem 220, and the stem 220 can be selectably, fixedly coupled to a stream shaper 222 that is engaged with the nozzle body 150 at its proximal end. As an example, a fastener 224 may be used to selectably (e.g., or fixedly) couple the baffle head 110 to the stem 220, and stem may comprise a portion that can selectably (e.g., or fixedly) couple with the stream shaper 222. In this implementation, the stream shaper 222 can be configured to couple with the nozzle body 150, for example, in a manner that keeps the stem 220, and therefore the baffle head 110, in a relatively non-movable condition while the nozzle 100 is in operation.

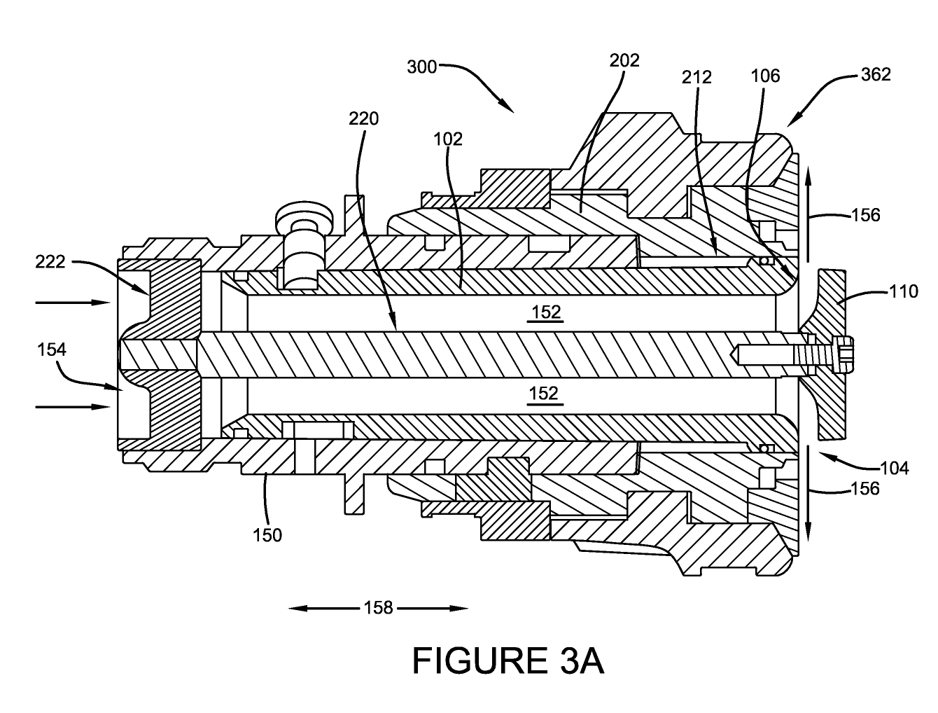

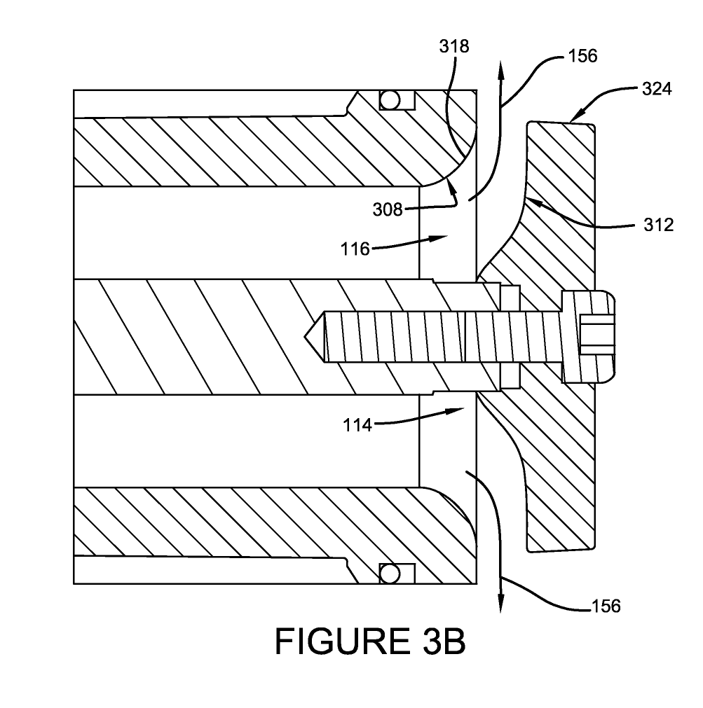

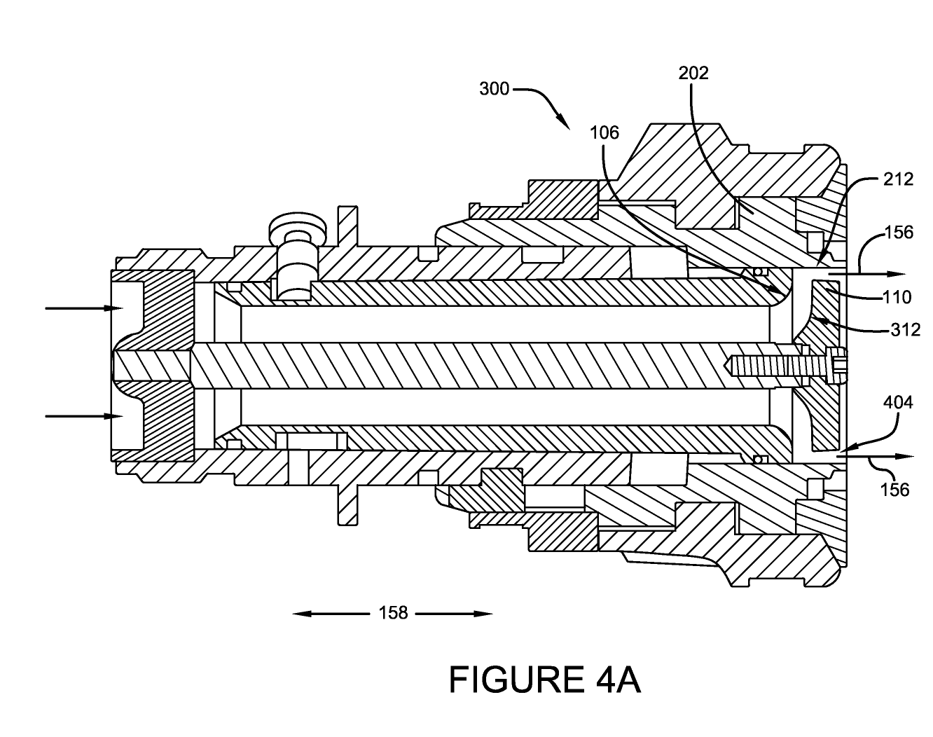

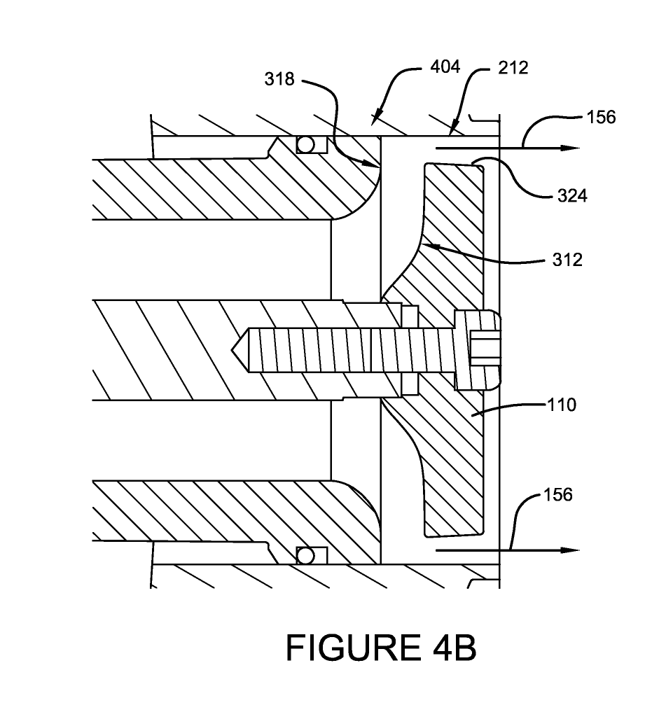

FIGS. 3A, 3B, 4A, and 4B are component diagrams illustrating examples of alternate implementations of a nozzle 300, and portions thereof. In FIG. 3A and 3B, the example nozzle 300 is disposed in a retracted position 362. In this implementation, the example nozzle 300 comprises the baffle head 110 that comprise an alternate baffle profile 324. The alternate baffle profile 324 can comprise a baffle face that is disposed at a third angle, where the third angle of the baffle profile 324 can be configured to create a diverging channel between the baffle profile 324 and the wall of a pattern tube 212 of the pattern sleeve 202. In this implementation, the output lip 106 of the discharge tube 102 can comprise an alternate convex shape 318; and the proximal side 114 of the baffle head 110 can comprise an alternate concave shape 312. Further, for example the combination of the alternate convex shape 318 and alternate concave shape 312 can result in a fluid flow output 156 being directed substantially perpendicular to the axis of nozzle fluid flow 158, when the pattern sleeve is disposed in the retracted position 362.

As illustrated in FIGS. 4A and 4B, the example nozzle 300 can be disposed in a straight stream profile, such as when the pattern sleeve 202 is disposed in an extended position 404. In this implementation, the baffle head 110 can be disposed inside the pattern tube 212, which can result in the output flow of fluid 156 being directed in a direction that is substantially parallel to the axis of nozzle fluid flow 158.

In one aspect, a pattern sleeve of a nozzle may be responsible for channeling and shaping the fluid stream into a desired firefighting straight stream profile, for example, as when used in a fog nozzle or radial spray pattern nozzle. In one implementation, in this aspect, a pattern sleeve travel may comprise a distance that the pattern sleeve can travel, measured from the distal end of the discharge tube. For example, as described above, the pattern sleeve can be retracted and extended between a radial pattern (e.g., wide fog) configuration and straight stream configuration. That is, for example, when the pattern sleeve is fully retracted the stream profile may comprise a radial pattern; while, when the pattern sleeve is fully extended the stream profile may comprise a straight stream pattern.

A nozzle may be devised that can improve a straight stream quality (e.g., at 40 and 60 gallons per minute (GPM) settings) and overall reach of fluid discharge from the nozzle. Further, the nozzle can be devised to mitigate a tendency of a discharge tube of the nozzle (e.g., and a pattern sleeve) to shift off center, which can distort a shape, quality, and direction of a straight stream, and may also narrow a fog spray patterns. In one implementation, in this aspect, increasing the pattern stream travel can improve straight stream convergence, for example, when applied to a fog nozzle design. Further, disposing an O-ring (e.g., or some other type of gasket/seal) between a nozzle body and discharge tube at a stabilizing location may mitigate the discharge tube from shifting off-center during use.

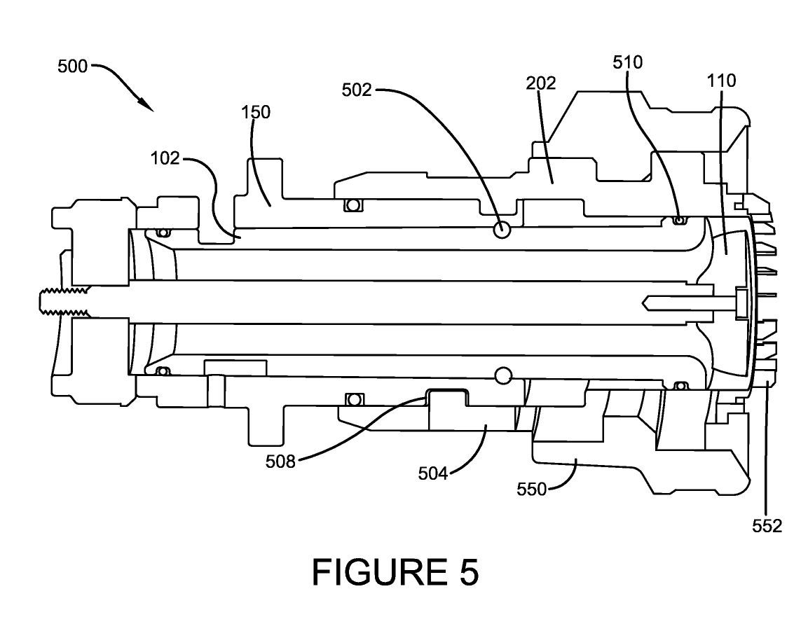

FIG. 5 is a component diagram illustrating an alternate implementation of and example nozzle 500. In this aspect, in one implementation, the example nozzle 500 can comprise a first gasket ring 502 (e.g., O-ring) disposed between the nozzle body 150 and the discharge tube 102, where the first gasket ring 502 can be configured to mitigate offset from center of the discharge tube 102 during operation of the nozzle. For example, as illustrated in FIG. 5, the first gasket ring 502 can be disposed at a generally central portion (e.g., central third) of the discharge tube 102. In this way, for example, as the first gasket ring 502 contacts both the discharge tube 102 and nozzle body 150, the first gasket ring 502 can bias the discharge tube 102 inward from the nozzle body 150 at the central portion. By disposing the first gasket ring 502, the discharge tube 102 may maintain a centralized disposition in the nozzle 500 during fluid flow through the nozzle 500.

In one implementation, a second gasket ring 510 (e.g., O-ring) can be disposed between the nozzle body 150 and the discharge tube 102 at a substantially distal end of the discharge tube 102. In this implementation, the second gasket ring 510 can be configured to mitigate an offset from center of the discharge tube 102 during operation. That is, for example, disposing the second gasket ring 510 at the distal end of the nozzle body 150 can provide stability for the discharge tube 102 by biasing the discharge tube 102 in a concentric disposition, relative to the nozzle body 150, which also helps maintain a concentric disposition relative to the pattern sleeve 202, and the baffle head 110. In this way, for example, the second gasket ring 510 can mitigate movement of the discharge tube 102 (e.g., and the pattern sleeve) toward one side of the nozzle 500, and out of concentric alignment with the baffle head 110, thereby maintaining concentricity between the discharge tube 102 and nozzle body 150, which can improve stream quality and overall reach of fluid discharge.

In one implementation, as illustrated in FIG. 5, the nozzle 500 can comprise a pattern sleeve 202 that is operably engaged with the discharge tube 102. In this implementation, the pattern sleeve 202 may be driven by a cam insert 504 that is configured to provide greater than 0.240 inches of pattern sleeve travel when one-hundred and eighty degrees of rotation is applied. That is, for example, the cam insert 504 may comprise a thread lead (e.g., or pitch for a single start thread) of greater than 0.500 inches, such as a thread lead of 0.812 inches (e.g., 13/16 inches). In this implementation, for example, having a greater thread lead may allow for increased pattern sleeve travel, which can allow the pattern sleeve 202 to extend a greater distance from a distal end of the discharge tube 102. As an example, extending the pattern sleeve 202 a desired distance from a distal end of the discharge tube can improve the convergence of the fluid stream profile, which can improve a stream quality and overall reach of the fluid.

As illustrated in FIG. 5, in one implementation, the cam insert 504 can comprise a component that couples the pattern sleeve 202 to the nozzle body 150, by way of a thread channel 508 disposed in the nozzle body 150. That is, for example, the cam insert 504 may be engaged with the pattern sleeve 202, and may also be slidably engaged with the thread channel 508 disposed on the exterior of the nozzle body 150. In this implementation, the thread channel 508 may be disposed around the perimeter of the nozzle body 150 in a thread pattern (e.g., spiral pattern), comprising the desired thread lead (e.g., greater than 0.500 inches). In this example, when a rotational force is applied to the pattern sleeve 202, such as by using a bumper 550 engaged with the pattern sleeve 202, the coupled cam insert 504 can slide rotationally in the thread channel 508 to convert the rotational force into a lateral movement of the pattern sleeve 202 with respect to the nozzle body 150. As an example, when looking at the nozzle in FIG. 5, when the pattern sleeve 202 is rotated down (e.g., to the right, by way of the bumper 550) the pattern sleeve 202 can extend (e.g., as in FIG. 2A); and when the pattern sleeve 202 is rotated up (e.g., to the left) the pattern sleeve 202 can retract (e.g., as in FIG. 1A).

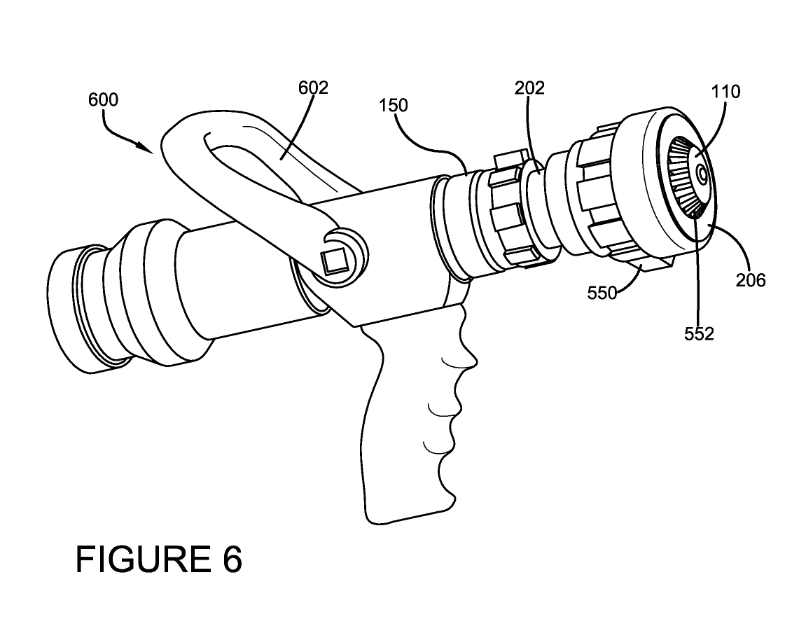

FIG. 6 is a component diagram illustrating an example nozzle 600 shown in profile, as may be assembled in a completed manner. In this example, the nozzle 600 comprises the nozzle body 150, a mechanism 602 for opening and closing the fluid flow, and the bumper 550, which is engaged with the pattern sleeve (e.g., 202). Further, in this implementation, the nozzle comprise a turbine 552, which may be disposed in the path of the output fluid flow (e.g., 156) and configured to provide a more uniform spray pattern. Additionally, in this implementation, pattern sleeve is disposed in the retracted position, thereby disposing the baffle head 110 above the distal face 206 of the pattern sleeve 202. In this way, for example, the output flow of fluid may be directed in a substantially perpendicular direction from the direction of fluid flow through the nozzle 600.

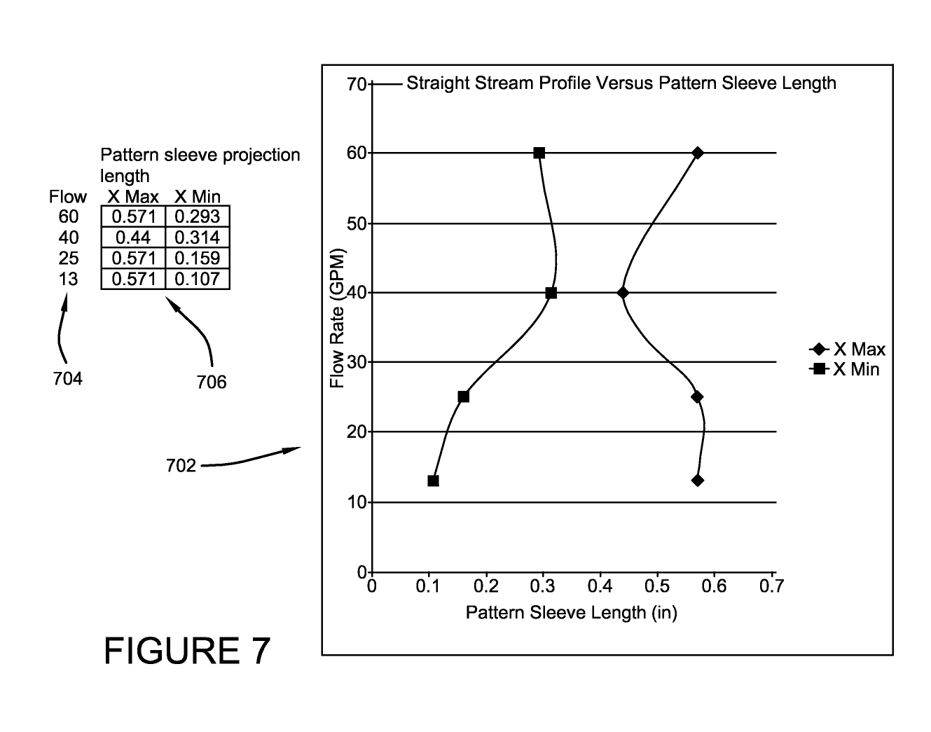

In one aspect, a desired pattern sleeve travel may comprise a distance that achieves a desired straight stream profile when the pattern sleeve is extended. That is, for example, depending on the characteristics of one or more other components of the nozzle, such as the baffle head 110, discharge tube 102, stream shaper 222, nozzle body 150, and/or a turbine 552 coupled with the nozzle 500, etc., overextending the pattern sleeve 202 may produce a less desirable straight stream profile, while under-extending the pattern sleeve may also produce a less desirable straight stream profile. Therefore, in one implementation, the desired travel distance may comprise a range of distances, which can include a distance that provides a desirable straight stream profile (e.g., providing a longer fluid reach) of the fluid (e.g., depending on the fluid). The desired pattern sleeve travel may be different for different nozzle sizes, and different nozzle diameters. As an illustrative example, FIG. 7 is a graphical representation 702 illustrating an exemplary set of plots 704 of various pattern sleeve travel 706 and resulting fluid stream profiles. This example implementation illustrates the result of over and under extension, along with a desired pattern sleeve travel.

As an illustrative example, an example nozzle (e.g., 500) may comprise an improved cam insert 504 (e.g., comprising ABS plastic) comprising a 13/16″ thread lead. In this example, an evaluation of the nozzle's straight stream profile and fluid reach characteristics is illustrated in FIG. 7. In this illustrative example, the straight stream profile of a first nozzle at 40 GPM and 60 GPM, with the improved cam insert is significantly improved when compared to a second nozzle that utilizes a cam insert having a thread lead of less than or equal to 0.500″. A comparison of the nozzle steam profiles of the first nozzle and second nozzle illustrates that the first nozzle, comprising the improved cam design (e.g., 504) can result in an improved convergent stream profile, and at least a twenty percent improvement in fluid stream reach (e.g., distance of fluid travel from the nozzle). The following fluid reach distances may be achieved by the improved cam design and resulting pattern sleeve travel: 116 feet at 61 GPM; 101 feet at 45 GPM; 88 feet at 28 GPM; and 66 feet at 20 GPM.

The various components of a nozzle described herein (e.g., 100, 300, 500) may be comprise of any materials suitable for use with the nozzle and the expected environments including, without limitation, metal, plastic, flexible materials such as rubber, and composites. In addition, the various components of nozzle described herein (e.g., 100, 300, 500) may be formed in any conventional manner including, without limitation, casting, machining, forming, molding and stamping. Furthermore, the various components of nozzle described herein (e.g., 100, 300, 500) may be finished in any conventional manner, such as painting, coating or plating, or may be left unfinished. Additionally, the various components of nozzle may be combined, integrated and assembled together in any convenient manner.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

What is claimed is:

1. A nozzle, comprising:
a discharge tube operably coupled with a nozzle body, the discharge tube forming a fluid passage configured to carry fluid to an output end, the discharge tube terminating in an output lip at the output end, the output lip comprising a first convex shape; and
a baffle head operably coupled with the nozzle body, and comprising a concave shape, the baffle head disposed distally from the output end of the discharge tube to form a fluid discharge channel between the output lip and the baffle head;
the fluid discharge channel defined by the first convex shape of the output lip and the concave shape of the baffle head, the fluid discharge channel comprising a converging channel configured to direct an output flow of fluid substantially perpendicular to an axis of nozzle fluid flow.

2. The nozzle of claim 1, the first convex shape of the output lip comprising a first radius of curvature, and the concave shape of the baffle head comprising a second radius of curvature.

3. The nozzle of claim 2, a diameter of a circle defined by a tangency point on the first radius of curvature at the distal end of the output lip is less than a minor diameter of the second radius of curvature of the baffle head, the second radius of curvature comprising an ellipse arc.

4. The nozzle of claim 1, the side of the baffle head comprising a baffle profile configured to perform one or more of the following when the nozzle is disposed in a straight stream pattern configuration:
increase a speed of the fluid flow to a fluid output; and
mitigate fluid flow turbulence and fluid flow back pressure.

5. The nozzle of claim 4, the baffle profile comprising a second convex shape comprising one or more of:
a third radius of curvature; and
a first face disposed at a first angle and a second face disposed at a second angle.

6. The nozzle of claim 1, comprising a pattern sleeve operably coupled with the nozzle body, the pattern sleeve configured to selectably translate along the axis of nozzle fluid flow between a retracted position and an extended position.

7. The nozzle of claim 6, the pattern sleeve comprising a distal face that lies in a plane substantially perpendicular to the axis of nozzle fluid flow, and the retracted position disposing the distal face of the pattern sleeve at or below a plane formed by the output end of the discharge tube.

8. The nozzle of claim 6, the pattern sleeve comprising a pattern tube that is operably coupled with the output end of the discharge tube, and when the pattern sleeve is disposed in the extended position the baffle head is disposed substantially inside the pattern tube resulting in an output flow of fluid from the distal end that is substantially parallel to the axis of nozzle fluid flow.

9. The nozzle of claim 6, the pattern sleeve utilizing a cam insert configured to provide greater than 0.240 inches of pattern sleeve travel with one-hundred and eighty degrees of rotation.

10. The nozzle of claim 1, the discharge tube selectably, non-movably coupled to the nozzle body.

11. The nozzle of claim 1, the baffle head coupled to a stem, the stem selectably, non-movably coupled to a stream shaper engaged with the nozzle body at its proximal end.

12. The nozzle of claim 1, comprising a gasket ring disposed between the nozzle body and the discharge tube, the gasket ring configured to mitigate offset from center of the discharge tube during operation.

13. A fluid discharge nozzle comprising:
a nozzle body;
a discharge tube operably engaged with the nozzle body;
a pattern sleeve operably engaged with the discharge tube, the pattern sleeve configured to selectably translate along an axis of nozzle fluid flow between a retracted position and an extended position; and
a baffle head operably engaged with the nozzle body and disposed in relation with the discharge tube to form a discharge opening, the discharge opening configured to direct an output flow of fluid substantially perpendicular to the axis of nozzle fluid flow when the pattern sleeve is disposed in the retracted position.

14. The nozzle of claim 13, the fluid discharge channel comprising a converging channel configured to increase accelerate fluid flow to a fluid output.

15. The nozzle of claim 13, the discharge tube comprising a curved output lip at an output end of the discharge tube, the output lip comprising a tangency point on a first radius of curvature of the output lip that defines a diameter of a circle, the diameter of the circle defined by the tangency point of the first radius of curvature is less than or equal to a minor diameter of a second radius of curvature of the baffle head, the second radius of curvature comprising an ellipse arc.

16. The nozzle of claim 13, the pattern sleeve configured to utilize a cam insert configured to selectably provide greater than 0.240 inches of pattern sleeve translation with one-hundred and eighty degrees of rotation.

17. The nozzle of claim 13, the pattern sleeve configured to discharge fluid from an output end substantially parallel to the axis of nozzle fluid flow when the pattern sleeve is disposed in the extended position.

18. The nozzle of claim 13, a distal end of the pattern sleeve comprising a planar surface at an output end of the nozzle, the planar surface of the discharge tube configured to be disposed co-planar or sub-planar to a plane formed by the distal end of the discharge tube when the pattern sleeve is disposed in the retracted position.

19. The nozzle of claim 13, comprising a gasket ring disposed between the nozzle body and the discharge tube, the gasket ring disposed at a central portion of the discharge tube and configured to mitigate offset from center of the discharge tube during operation.

20. A fluid discharge nozzle comprising:
a nozzle body;
a discharge tube operably engaged with the nozzle body;
a baffle head operably engaged with the nozzle body and disposed in relation with the discharge tube to form a discharge opening; and
a pattern sleeve operably engaged with the discharge tube, the pattern sleeve configured to selectably translate along an axis of nozzle fluid flow between a retracted position and an extended position;
the nozzle configured to provide greater than one hundred and seventy degrees of a radial spray pattern discharge, and one or more of:
greater than one-hundred feet of fluid reach at a flow of sixty gallons per minute (GPM);
greater than ninety feet of fluid reach at a flow of forty GPM;
greater than eighty feet of fluid reach at a flow of twenty-five GPM; and
greater than sixty feet of fluid reach at a flow of thirteen GPM.
